(19) United States
(12) Patent Application Publication
(10) Pub. No.: US 2022/0165304 A1
(43) Pub. Date: May 26, 2022

(54) TRIGGER-RESPONSIVE CLIP EXTRACTION BASED ON REMOTE ANALYSIS

(71) Applicant: NVIDIA Corporation, Santa Clara, CA (US)

(72) Inventors: Milind Ramesh Naphade, Cupertino, CA (US); Parthasarathy Sriram, Los Altos Hills, CA (US); Shuo Wang, San Jose, CA (US)

(21) Appl. No.: 17/103,715

(22) Filed: Nov. 24, 2020

(51) Int. Cl. G11B 20/10; H04N 5/765; G06N 3/04

(52) U.S. Cl. CPC G11B 20/10527; G11B 2020/10712; G06N 3/04; H04N 5/765

(57) ABSTRACT

Intelligent Video Analytics system may be implemented using a distributed computing architecture with edge and remote devices, where the edge devices analyze the video stream and transmit detection data corresponding to time segments to the remote device. The detection data may identify an object (e.g., vehicle, pedestrian, etc.) in the video stream. The remote device analyzes the detection data received from one or more edge devices and generates extraction triggers that are transmitted to the one or more edge devices. When an edge device receives an extraction trigger, the edge device extracts a clip from the video stream and stores the clip to persistent storage. The remote device may then retrieve the clip. The edge devices may perform simple identification operations while the remote device implements complex algorithms to detect events, benefitting from a larger context than is available to the individual edge devices.

### BACKGROUND

Intelligent Video Analytics (IVA) systems are used to analyze video streams and provide results of the analysis in real-time. A popular deployment of an IVA system is implemented using a distributed computing architecture with edge and cloud devices. In typical deployments, the edge devices will analyze the video stream to detect events and store portions of video related to the events, and transmit metadata corresponding to the events to the cloud device. The metadata is then used to identify specific objects (e.g., cars and pedestrians) and timestamps. In typical deployments, cloud devices can retrieve the portions of video from the edge devices.

Because each edge device analyzes the video stream that is captured by the edge device in isolation, some events of interest may be missed. The cloud device benefits from a larger context as a result of receiving metadata from multiple edge devices. Based on further analysis of the metadata and/or retrieved portions of video in the greater context, the cloud device or a user of the cloud device may determine that additional portions of video should be examined. However, the edge devices do not typically store the entire video stream that was captured. Even the portions that are stored may be overwritten by subsequently captured video and are therefore not available for an indefinite amount of time. Thus, the additional portions of video needed by the cloud device may not be available in the edge devices and cannot be retrieved. There is a need for addressing these issues and/or other issues associated with the prior art.

### SUMMARY

Embodiments of the present disclosure relate to trigger-responsive clip extraction at an edge device based on remote analysis. According to embodiments, each edge device detects objects, instances, and/or occurrences present in a continuous data stream and generates detection data that is transmitted to a remote device. The edge devices may perform simple identification operations while the remote device implements complex algorithms to identify events, benefitting from a larger context than what would be available to the individual edge devices. The detection data received from multiple edge devices may be analyzed over time by the remote device.

Based on the analysis, the remote device determines which time segments of the data streams buffered in the edge devices should be extracted and stored. The remote device generates extraction triggers that are transmitted to one or more of the edge devices, causing the one or more edge devices to extract and store clips of the buffered data stream to persistent storage. The remote device may then retrieve the clips. The extraction triggers provide a mechanism for extracting clips from one or more data streams buffered in one or more edge devices based on remote analysis. The continuous acquisition of data and identification of objects by the edge devices is decoupled from the analysis performed by the remote device. In other words, the analysis may be performed asynchronously with the acquisition and identification. In contrast, conventional systems perform the capture and analysis within each edge device.

### BRIEF DESCRIPTION OF THE DRAWINGS

The present systems and methods for trigger-responsive clip extraction based on remote analysis are described in detail below with reference to the attached drawing figures, wherein:

FIG. 1A illustrates a block diagram of an example distributed stream analysis and storage system suitable for use in implementing some embodiments of the present disclosure.

FIGS. 1B-1D illustrate contents of a rolling buffer over time, transmission of detection data, and storing a clip, in accordance with an embodiment.

FIG. 2A illustrates a flowchart of a method for trigger-controlled clip extraction, in accordance with an embodiment.

FIG. 2B illustrates another block diagram of an example distributed stream analysis and storage system suitable for use in implementing some embodiments of the present disclosure.

FIG. 3 illustrates a flowchart of a method for generation of extraction trigger generation suitable for use in implementing some embodiments of the present disclosure.

FIG. 4 illustrates an example parallel processing unit suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

### DETAILED DESCRIPTION

Systems and methods are disclosed related to trigger-responsive clip extraction based on remote analysis. A mechanism for extracting clips from a data stream in response to receiving a trigger from a remote analysis service enables the acquisition and detection operations to be decoupled from the remote analysis. Furthermore, acquisition is not interrupted and is decoupled from the extraction and storage of clips. The mechanism is particularly useful for extracting and storing video clips from continuous real-time video streams buffered in edge devices based on analysis performed using multiple real-time video streams over time.

In contrast to conventional systems, such as those described above, when an extraction trigger is received by the edge device, a clip is extracted from the buffered real-time video stream and stored in persistent storage associated with the edge device. Therefore, the edge devices may not store the entire captured video stream to persistent storage. The real-time video stream that is received during the remote analysis is buffered at the edge device to compensate for the latency incurred while the remote device performs the analysis. The remote device benefits from a larger context as a result of receiving detection and/or streaming data from multiple edge devices, reducing the likelihood that some events of interest are missed. When an edge device receives an extraction trigger from the remote device, a clip specified by the extraction trigger is extracted from the buffered data stream and stored. The burden of identifying portions of the data stream that are stored for further analysis can be advantageously removed from the edge devices. Overall efficiency of the distributed system may be improved because portions of the data stream that are not needed are not stored, and the edge devices may perform identification tasks while the more complex analysis is performed by the remote device. Also, portions of the data stream that would not necessarily be stored based on analysis by an individual edge device may be identified by the remote analysis and stored by the edge device in response to the extraction trigger.

Disclosed embodiments may be implemented using a variety of different systems such as automotive systems, robotics, aerial systems, boating systems, smart area monitoring, simulation, and/or other technology areas. Disclosed approaches may be used for any perception-based or more generally image-based analysis, monitoring, and/or tracking of objects and/or the environment.

Analyzing traffic at intersections and along roadways is vital to managing traffic flow, minimizing congestion and GHG emissions, maximizing the safety of pedestrians and vehicles, and responding to emergency situations. While there is an increasing proliferation of cameras along our road networks, existing systems have been unable to monitor camera feeds in real-time and use the information to effectively manage or otherwise react to certain traffic conditions along roadways. For example, these existing systems may have limited capabilities that only allow for detecting a fixed set of observation types. In particular, specific rules may typically be tailored to perform video analysis. For example, existing approaches may require specific input to customize video analysis of traffic camera data for each camera at each location. This may be the result of the extensive variability that exists in the visual information being captured by cameras located at different locations. Such visual variability may occur for any number of reasons, such as, as a function of the camera, the camera vantage point, the scene being observed, the environment, weather conditions (e.g., wind, rain, hail, dust etc.), and/or the time of day (e.g., impacting ambient lighting, shadows etc.). Because of the extensive visual variations that may result for each camera, it may be inefficient and ineffective to generate customized video analytics to cover the vast amount of conditions that each individual camera will encounter, and even more so that different cameras will encounter, thereby impeding effective use of these traffic cameras for extracting relevant and timely insights about traffic flow, safety, and incidents.

Accordingly, embodiments described herein are directed to tracking objects, such as vehicles, machines (such as robots), or pedestrians, and using the object trajectories to identify object movement events. At a high level, a monitoring or sensor device(s) (e.g., a camera) may continuously monitor a region of the physical environment. Continuous monitoring of object movement may also enable identification of various trajectory features, such as average speeds, vehicle flow, etc. Detection of an object may be performed at an edge device while the object movement may be monitored and analyzed by the remote device to identify the object movement events.

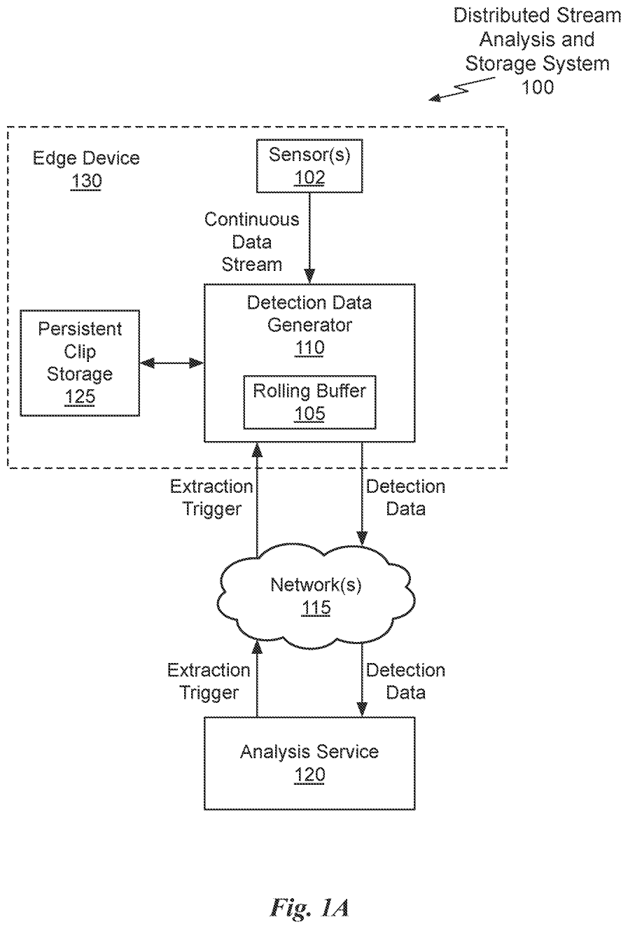

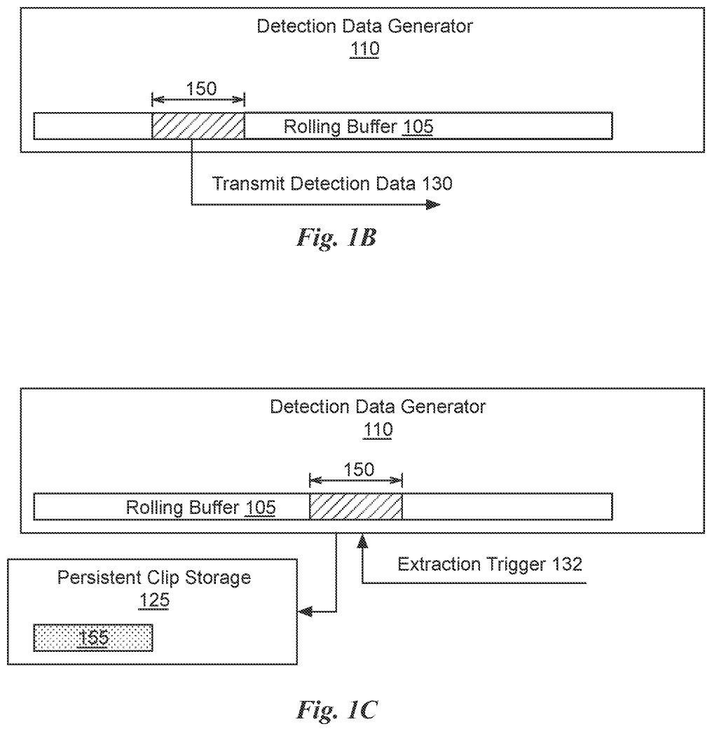

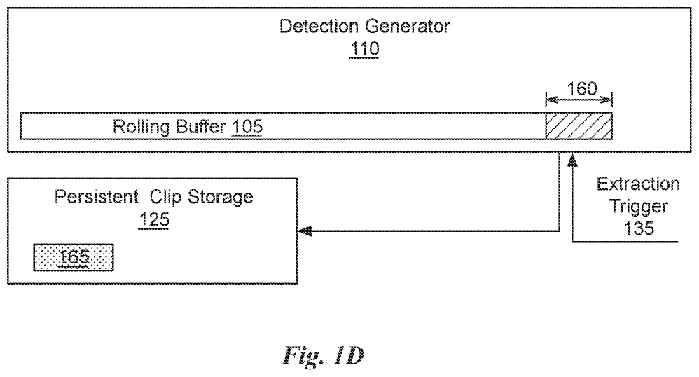

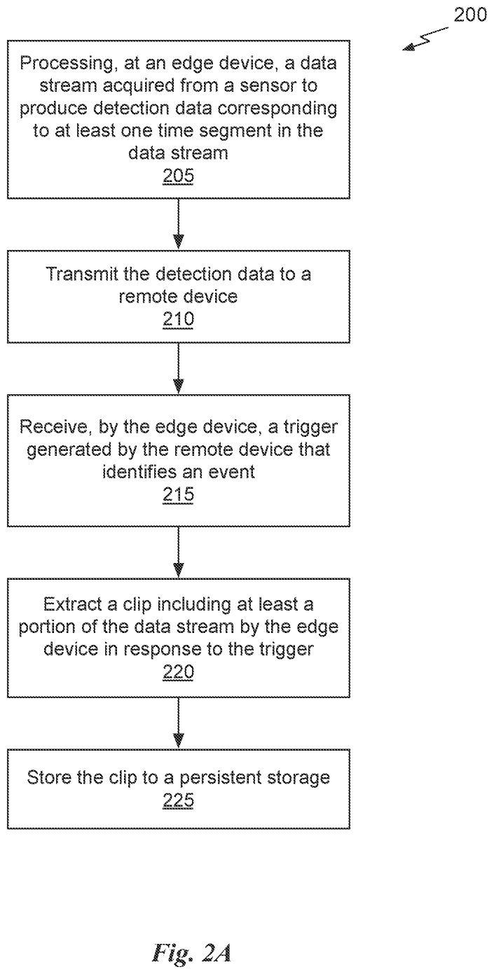

FIG. 1A illustrates a block diagram of an example distributed stream analysis and storage system 100 suitable for use in implementing some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the distributed stream analysis and storage system 100 is within the scope and spirit of embodiments of the present disclosure.

As depicted in FIG. 1A, embodiments of the distributed stream analysis and storage system 100 can include an edge device 130, network(s) 115, and an analysis service 120. The purpose of the distributed stream analysis and storage system 100 is to store interesting clips of the real-time data stream, where “interesting” is determined according to analysis over time and/or based on data streams captured by at least one edge device 130. The edge device 130 generates detection data by processing a real-time continuous data stream acquired by one or more sensor(s) 102.

In deployment, the sensor(s) 102 may collect or capture a continuous data stream in an environment. The continuous data stream may include image data—representative of still images or a video—that depict object movement. In one or more embodiments, one or more sensors 102 may include, for example, a camera (e.g., a video camera, a monocular camera, a stereoscopic camera, a 360 degree camera, a wide-view camera, etc.) positioned within the environment may be used to acquire data (e.g., images and/or video) of the environment within a field(s) of view of the camera(s). As another example, one or more light detection and ranging (LIDAR) sensors, infrared (IR) sensors, radio detection and ranging (RADAR) sensors, weather sensors, speed sensors, and/or other sensor types may be able to capture a temperature, a wind velocity, a precipitation measure, object speeds, accelerations, and/or velocities, and/or the like, of one or more aspects of the weather or the objects (e.g., vehicles, pedestrians, animals, drones, aircraft, etc.) in the environment. In an example, one or more sensors 102 (e.g. microphones) may capture sounds in the environment. The real-time continuous data stream may be any type of continuous data provided by the sensor(s) 102, such as audio, video, temperature, air quality, etc.

The detection data generator 110 processes the continuous data stream acquired by the sensor(s) 102 to produce detection data corresponding to at least one time segment in the data stream. The detection data may indicate the presence of an object, occurrence, or instance in the data stream during the time segment. Examples of detection data include classification data, object segmentation data, and position data. The detection data may indicate time segments that correspond to objects in a video stream, sounds in an audio stream, and the like. For example, the detection data may include location and attributes (color, shape) of identified objects (cars). In an embodiment, the edge device 110 is configured to identify the presence of the object, occurrence, or instance in the data stream using predetermined criteria.

In an embodiment, the detection data generator 110 generates annotations (e.g., bounding boxes, labels, or coordinates) that are included in the detection data. Annotations could represent the location(s) and/or dimensions of a bounding box (e.g., a geometric shape whose location and dimensions can change frame-to-frame indicating the temporal tracking of an object) of an object and/or could represent other attributes of an identified object in a video. The detection data generated by the detection data generator 110 can represent any detectable aspect of a video frame such as visual features of the video frame. The detection data generator 110 may generate detection data that is associated with a frame of video data using a timestamp corresponding to a time segment. For example, the detection data generator 110 may generate detection data for a frame of video data with a specific timestamp and may synchronize the frame and detection data by associating the detection data with that timestamp. As an example, the timestamp associated with the detection data may be used to extract a clip from the rolling buffer 105. The detection data generator 110 may transmit the generated detection data for each frame, which has been associated with a timestamp, to the analysis service 120 via the network(s) 115.

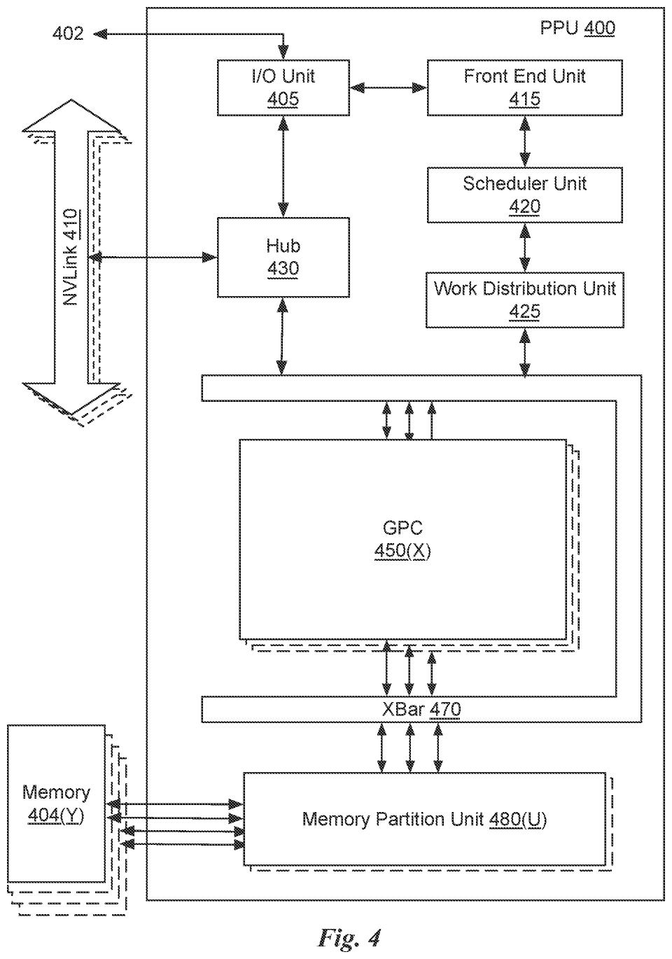

In an embodiment, the detection data generator 110 uses one or more Machine Learning Models (MLMs) to detect vehicle and/or vehicle locations in video frames and generate the detection data. Another detection data generator 110 may use one or more MLMs to detect pedestrians and/or pedestrian locations in video frames and generate the detection data corresponding to the detected pedestrians. These detection data generators 110 may be included within the same edge device 130 or different edge devices 130 and may operate on the same or different video streams in serial and/or in parallel. As described herein, the MLMs may be implemented using one or more multi-core processors, GPUs and/or virtual CPUs or GPUs, such as of a parallel processing unit (PPU) 400 of FIG. 4.

Conventionally, an edge device may save all of a video stream to persistent, non-volatile, or permanent storage (e.g., disk or hard drive) so that the specific clips may be provided to a compute node for presentation or further analysis. Because, storing the entire video stream is expensive in terms of the storage resources, the entire video stream may instead be stored for a limited amount of time (e.g., 24 hours, week). Indiscriminately storing the entire video stream is expensive in terms of storage cost, but can provide sufficient time for analysis. Some conventional edge devices store portions of the video stream in response to predetermined activity (e.g., movement, sound). Storing only portions of the video stream also allows time for analysis, but frames of the video stream that are interesting based on the analysis may not have been selected for storage. Other video stream sampling techniques (e.g., storing one frame per minute) may also have low storage costs, but have similar drawbacks to storing only portions of the entire video stream.

As shown in FIG. 1A, the detection data generator 110 receives a continuous data stream that is simultaneously processed by the detection data generator 110 and written to the rolling buffer 105. In contrast with persistent storage, the rolling buffer 105 does not necessarily retain data when power is removed. The rolling buffer may be implemented using registers or physical or virtual RAM. In one or more embodiments, the rolling buffer 105 may have a limited capacity, so that once the buffer is full, the oldest data is overwritten with new data. In an embodiment, the rolling buffer 105 is a circular buffer. The detection data may also be written to the rolling buffer 105.

The detection data is transmitted through the network(s) 115 to an analysis service 120. In an embodiment, the detection data is transmitted via a message broker. In an embodiment, the analysis service 120 is located at a remote node and/or is included in a cloud device. The edge device 130 and analysis service 120 components in the distributed stream analysis and storage system 100 may communicate over network(s) 115. The network(s) 115 may include a wide area network (WAN) (e.g., the Internet, a public switched telephone network (PSTN), etc.), a local area network (LAN) (e.g., Wi-Fi, ZigBee, Z-Wave, Bluetooth, Bluetooth Low Energy (BLE), Ethernet, etc.), a low-power wide-area network (LPWAN) (e.g., LoRaWAN, Sigfox, etc.), a global navigation satellite system (GNSS) network (e.g., the Global Positioning System (GPS)), and/or another network type. In any example, each of the components of the distributed stream analysis and storage system 100 may communicate with one or more of the other components via one or more of the network(s) 115. In some examples, the network(s) 115 comprises one or more core and/or edge networks of a cloud computing system.

In an embodiment, the distributed stream analysis and storage system 100 is configured to detect vehicles and analyze paths and/or positions of the detected vehicles over time to identify traffic violations. Detection of vehicles is an example of predetermined criteria that the detection data generator 110 is configured to identify. Driving in a bicycle lane for more than a block is an example of predetermined criteria that is used by the analysis service 120 to generate extraction triggers. An individual edge device 130 that is installed at a fixed location may not acquire the images needed to determine that a vehicle has been in the bicycle lane for more than a block, while the analysis service 120 may receive sufficient detection data from multiple edge devices 130 at different locations to make the determination.

As previously described, the continuous data stream is first processed to detect objects and the detection data is transmitted to a remote node for analysis. The analysis performed by the analysis service 120 differs from detection in that behavior of a detected object, occurrence, or instance may be tracked over time and across different locations, particularly when multiple edge devices 130 provide detection data to the analysis service 120.

Based on analysis of the detection data, the analysis service 120 generates one or more extraction triggers that each specify clip(s) to be extracted from the real-time continuous data stream. The detection data is analyzed to determine which portions of the real-time data stream qualify as interesting and will be stored to a persistent clip storage 125. In an embodiment, the analysis service 120 generates annotations (e.g., bounding boxes, labels, or coordinates) that are included in the extraction trigger. The annotations may be stored with the clips.

The extraction trigger defines a portion of the continuous data stream stored in the rolling buffer 105 to be extracted to generate a clip. The portion is associated with a time segment and may be specified by time stamp, frame number, or the like. The extracted clip is then stored to the persistent clip storage 125 by the detection data generator 110. In an embodiment, annotations may be stored and/or combined with the clip. The analysis service 120 may retrieve clips stored in the persistent clip storage 125 via the network(s) 115.

Latency is introduced from the time when the continuous data stream is acquired, detection data is generated, detection data is analyzed, to when the extraction request for a clip of the continuous data stream stored in the rolling buffer 105 is received at the edge device 130. The capacity of the rolling buffer 105 should be adequate to accommodate the latency so that portions of the continuous data stream that are targeted for extraction by the analysis service 120 are not overwritten by new data.

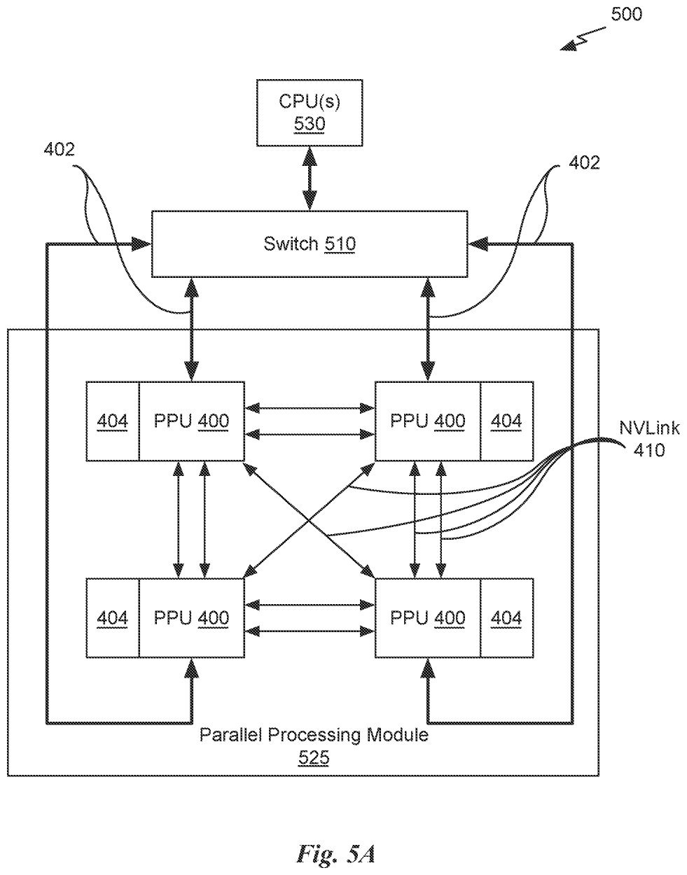

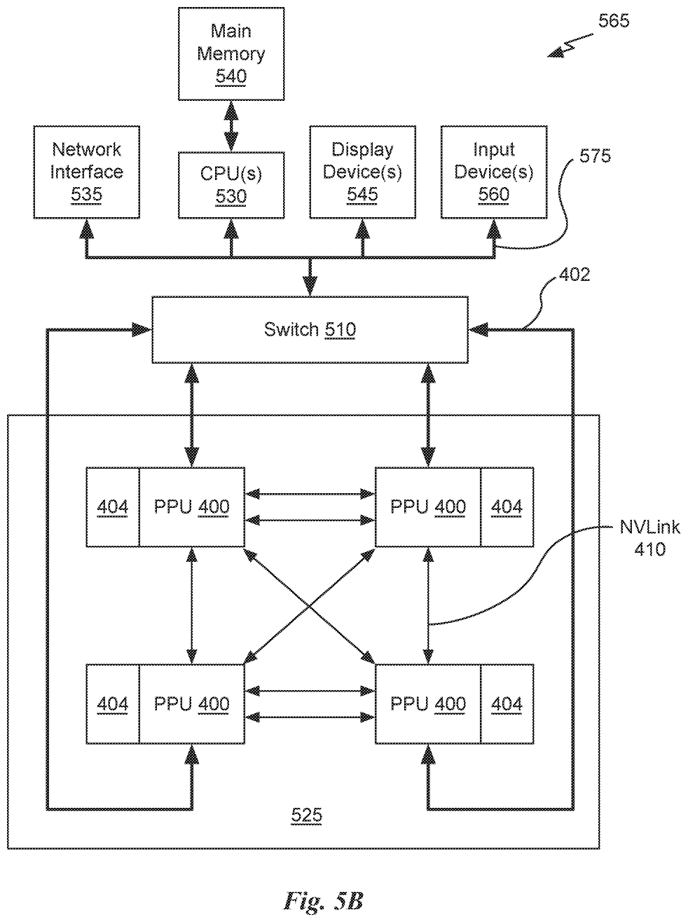

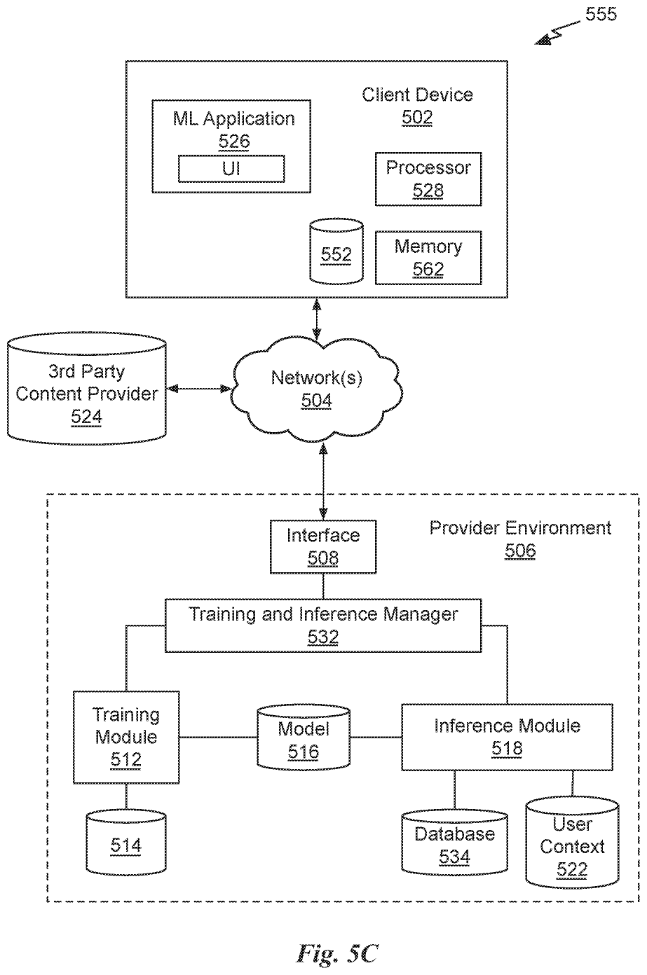

In an embodiment, the detection data is generated by an edge device and the trigger is generated by a core device in a cloud computing system so that the detection is decoupled from both the analysis of the detection data and storage of clips. The core device may receive detection data from multiple edge devices. Therefore, the extraction trigger may result from an integrated analysis over time and/or detection data based on multiple sensors 102 and/or edge device(s) 130. In an embodiment, the analysis service 120 comprises a neural network that is trained to analyze the detection data for specific behaviors. The analysis service 120 may be implemented as a recurrent neural network (RNN), long short-term memory (LSTM) neural network, convolutional neural network (CNN), or the like. In an embodiment, the system 555 illustrated in FIG. 5C may be used to train the analysis service 120.

Although the persistent clip storage 125 is shown within the edge device 130 in FIG. 1A, the persistent clip storage 125 may be external to the edge device 130 and coupled to the network(s) 115 or in a different edge device 130 that is also coupled to the network(s) 115. Regardless of the physical location of the analysis service 120 relative to the edge device 130, in an embodiment, the analysis service 120 does not share compute resources with the edge device 130. The analysis service 120 also cannot directly access data stored in the rolling buffer 105.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 1B illustrates contents of the rolling buffer 105 and transmission of detection data, in accordance with an embodiment. Conceptually, the rolling buffer 105 fills with new data from the left side, similar to a first-in first-out buffer, overwriting the oldest data stored in the rolling buffer 105. When the detection data generator 110 processes a portion of the continuous data stream corresponding to a time segment 150, detection data 130 is generated and transmitted to the analysis service 120 through the network(s) 115. The detection data 130 may include timestamps, locations, attributes of identified objects, attributes of identified instances, attributes of identified occurrences, annotations, frame numbers, or other information. The detection data 130 may also be written to the rolling buffer 105.

FIG. 1C illustrates storing a clip from the contents of the rolling buffer 105, in accordance with an embodiment. After the detection data 130 is received and analyzed by the analysis service 120, an extraction trigger is generated. The extraction trigger is transmitted from the analysis service 120 to the detection data generator 110 through the network(s) 115. In response to receiving the extraction trigger 132, the detection data generator 110 extracts a clip 155 from the rolling buffer 105 and stores the clip 155 to the persistent clip storage 125. In an embodiment, the clip 155 includes the entire time segment 150, a portion of the time segment 150, or a portion of the data stored in the rolling buffer 105 that does not include the time segment 150. The extraction trigger transmitted by the analysis service 120 specifies the portion of the continuous data stream to be extracted and stored. In an embodiment, the extraction trigger 132 is generated based on detection data received from a different edge device 130. In an embodiment, the extraction trigger 132 is generated based on detection data received from two or more edge devices 130.

The extraction trigger 132 may also specify whether any other information, such as attributes of identified objects, attributes of identified instances, attributes of identified occurrences, annotations, and/or frame numbers are included with the clip 155 and also stored to the persistent clip storage 125. In an embodiment, the extraction trigger 132 may specify or otherwise indicate timestamps that are used to identify one of more frames of a video stream(s) in the rolling buffer 105. Each timestamp may correspond to a frame of a video stream (e.g., a video stream with framerate of 30 fps may have a first frame with a timestamp and the subsequent frame may have a timestamp 33 ms later). The edge device 130 may store the video data indexed or otherwise associated with the timestamps (e.g., locally such as on site or remotely to an external location) in the rolling buffer 105 and/or the persistent clip storage 125.

The clips stored in the persistent clip storage 125 may be indexed based on any number of methods that may include but are not limited to, the timestamp(s) of the detection data, the classification of objects described by the detection data, the location at which the detection data was generated, attributes of the associated data stream, or any combination of methods.

FIG. 1D illustrates storing another clip from the contents of the rolling buffer 105, in accordance with an embodiment. As the rolling buffer 105 fills with new data from the left side, a portion of the time segment 150 stored in the rolling buffer 105 is overwritten and the remaining portion of the time segment 150 is a time segment 160. Compared with FIG. 1C, the latency from transmitting the detection data 130 for the time segment 150 until the time the extraction trigger 135 is received is greater than the latency from transmitting the detection data 130 until the time the extraction trigger 132 is received.

In an embodiment, the extraction trigger 135 specifies extracting a clip 165 that includes the entire time segment 160. In response to receiving the extraction trigger 135, the detection data generator 110 extracts a clip 165 from the rolling buffer 105 and stores the clip 165 to the persistent clip storage 125. The clip 165 includes the portion of the time segment 150 that is still available in the rolling buffer 105.

In an embodiment, a capacity of the rolling buffer 105 is configured to store an amount of the continuous data stream that is acquired during a maximum latency incurred until an extraction trigger is received. In one or more embodiments, the extraction trigger may be generated in response to analysis of detection data produced by the edge device 130. In contrast with conventional techniques that perform detection and analysis at the edge device in isolation, the distributed stream analysis and storage system 100 provides an on-demand trigger-driven event-driven storage that is efficient and cost effective. For example, the edge devices 130 may be low-cost energy efficient compute nodes while a remote (e.g., cloud or on-premise data server) node that includes the analysis service 120 is more complex and may be more easily accessible, and/or upgraded or replaced more frequently. Storing clips based on remote analysis enables more efficient use of the storage resources while ensuring that time segments identified as interesting are extracted and stored in the persistent clip storage 125.

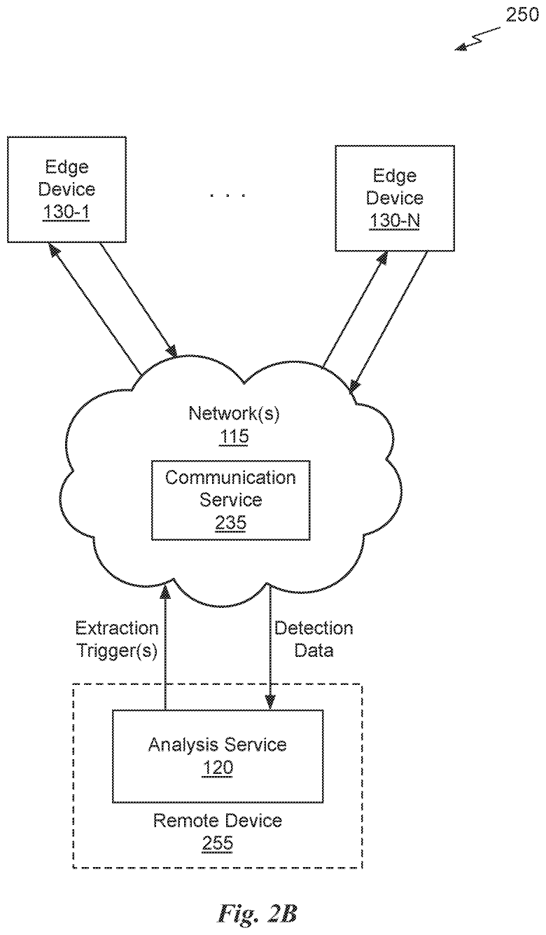

FIG. 2A illustrates a flowchart of a method 200 for trigger-responsive clip extraction, in accordance with an embodiment. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 is described, by way of example, with respect to the distributed stream analysis and storage system 100 of FIG. 1A. However, this method may additionally or alternatively be executed by any one system, or any combination of systems, including, but not limited to, those described herein. Furthermore, persons of ordinary skill in the art will understand that any system that performs method 200 is within the scope and spirit of embodiments of the present disclosure.

At step 205, an edge device 130 processes a data stream acquired from a sensor 102 to produce detection data corresponding to at least one time segment in the data stream. In an embodiment, the data stream is a continuous data stream. In an embodiment, the detection data is produced according to predetermined criteria. In an embodiment, the detection data is produced by a neural network. In an embodiment, the system 555 illustrated in FIG. 5C may be used to train the detection data generator 110. In an embodiment, the data stream is a video stream and the detection data corresponds to an object that is visible in the data stream. In an embodiment, the data stream is an audio stream and the detection data corresponds to a sound that is audible in the data stream. In an embodiment, the sensor 102 is one of a camera or a microphone.

At step 210, the detection data is transmitted to a remote device. In an embodiment, a communication service, included in the network 115, is configured to relay the detection data from the edge device to the remote device and relay the trigger from the remote device to the edge device 130. In an embodiment, the communication service is located in the cloud. In an embodiment, the remote device includes the analysis service 120. In an embodiment, at least one additional edge device 130 may be configured to transmit additional detection data to the remote device. In an embodiment, one or more events are identified by the remote device based on the detection data. In an embodiment, an event corresponds to a particular behavior that an analysis service 120 is trained to identify. For example, the analysis service 120 may be trained to identify specific violations, such as driving in a bicycle lane for more than a block or parking a car within a restricted area, or a vehicle making an illegal maneuver (such as, for example and without limitation, driving in the wrong direction, making a U-turn). An individual edge device 130 that is installed at a fixed location may not acquire the images needed to determine an event has occurred. In another example, the analysis service 120 may be trained to identify a pedestrian who has fallen.

In an embodiment, the remote device generates the trigger based on analysis of the detection data and the additional detection data. In an embodiment, the trigger is produced according to expected patterns of behavior. In an embodiment, the analysis is performed by a neural network. In an embodiment, the detection data and/or extracted clips may be used for training a neural network model. In an embodiment, the detection data may be used when the behavior is not associated with a learned event and the detection data and/or extracted clips may be examined to recognize unknown behaviors. In an embodiment the detection data and/or extracted clips may be used for training, testing, or certifying a neural network model that is employed in a machine, robot, or autonomous vehicle.

At step 215, the edge device 130 receives a trigger that is generated by the remote device and that identifies an event. In an embodiment, the trigger is an extraction trigger. In an embodiment, the trigger is generated based on analysis of the detection data. At step 220, in response to the trigger, the edge device extracts a clip that includes at least a portion of the data stream. In an embodiment, the trigger specifies a timestamp within the continuous data stream and a duration of the clip. In an embodiment, a buffer is configured to store a portion of the continuous data stream from which the clip is extracted. In an embodiment, the buffer is the rolling buffer 105. At step 225, the clip is stored to a persistent memory, such as the persistent clip storage 125. In an embodiment, annotation data corresponding to the clip is also stored.

FIG. 2B illustrates another block diagram of an example distributed stream analysis and storage system 250 suitable for use in implementing some embodiments of the present disclosure. The system 250 includes a remote device 255, the network(s) 115, and multiple (N) edge devices 130 (e.g., edge device 130-1, . . . 130-N). In an embodiment, the remote device 255 is a server or a core device of a cloud computing system. Each edge device 130 acquires continuous streaming data from one or more sensor(s) 103 and generates detection data. The detection data is transmitted to the remote device 255, which includes the analysis service 120. In an embodiment, the remote device 155 includes multiple analysis services 120 and each analysis service 120 may be configured to analyze the detection data to identify different types of events.

In an embodiment, the detection data and extraction trigger(s) are transmitted via a communication service 235 within the networks(s) 115. In an embodiment, the communication service 235 is a message broker that enables asynchronous operation of the edge devices 130 and the remote device 155. In an embodiment the communication service 235 is in the cloud. In an embodiment, the communication service 235 uses defined policies to determine which analysis service 120 and/or remote device 255 should receive detection data. For example, a first analysis service 120 may define a policy to receive only detection data corresponding to vehicles and a second analysis service 120 may define a policy to receive only detection data corresponding to people. The communication service 235 receives the extraction trigger(s) for the N edge devices 130 and transmits each extraction trigger to one or more of the edge devices 130 specified by the extraction trigger. In an embodiment, the remote device 255 and/or one or more of the edge devices 130 may be configured to display the clips with or without annotations.

In an embodiment, the analysis service 120, tracks movement of a vehicle identified by multiple edge devices 130 over time. The analysis service 120 may integrate detection data transmitted by multiple edge devices 130 to determine which portions of the continuously stored data in one or more of the rolling buffers 105 should be extracted and stored. For example, the remote device 255 may analyze detection data received from one or more edge devices 130 for the same time segment. The remote device 255 may analyze detection data received from one or more edge devices 130 for different time segments.

In an embodiment, the communication service 235 implements time synchronization across devices of the distributed stream analysis and storage system 250 in order for the timestamps and detection data to be synchronized across the distributed stream analysis and storage system 250. For example, the edge devices 130 may connect to an Internet Protocol (IP) network and run a Network Time Protocol (NTP) daemon to sync time with the remote device 255 and determine synchronized timestamps for incoming video data). When the video data is processed and/or generated, the timestamps may be associated with corresponding frames for storage in the persistent clip storage 125 and to be extracted from the rolling buffer 105.

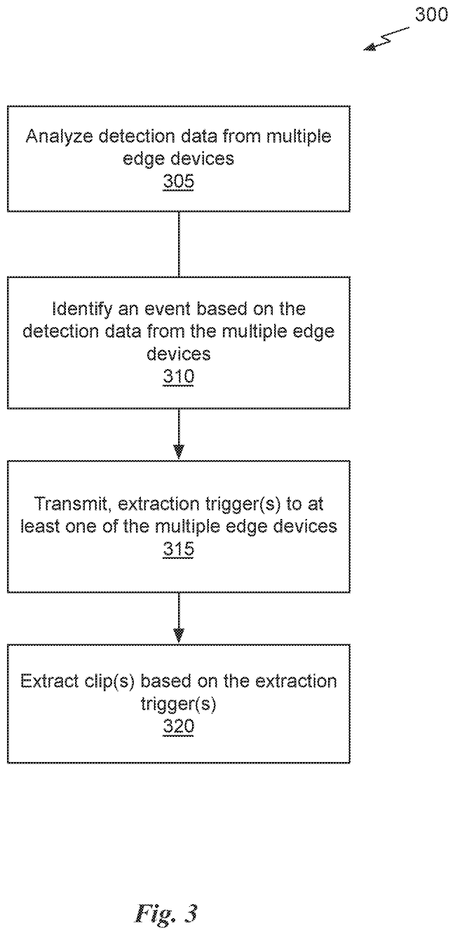

FIG. 3 illustrates a flowchart of a method 300 for extraction trigger generation suitable for use in implementing some embodiments of the present disclosure. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the distributed stream analysis and storage system 100 of FIG. 1A or system 250 of FIG. 2B. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 305, detection data from multiple edge devices 130 is analyzed by an analysis service 120 within the remote device 255. The detection data provided by each edge device 130 corresponds to at least one time segment. At step 310, the analysis service 120 identifies an event based on processing of the detection data received from the multiple edge devices 130.

In an embodiment, the detection data (e.g., image data, LIDAR data, RADAR data, etc.) may be analyzed to identify or determine object trajectories, perform facial recognition, classify objects, and the like. An object trajectory may refer to a path followed by a moving object in addition to, in some examples, one or more attributes or characteristics of the object along the path (e.g., speed, velocity, acceleration, turning angle, yaw rate, etc.). Although an object is generally referred to herein as a vehicle (e.g., car, truck, bike, motorcycle, etc.), an object may be any moving item, such as a person, an animal, another vehicle type, an inanimate object, etc.

An object trajectory may be represented in any number of ways. One way in which an object trajectory may be represented includes a set or series of positions or coordinates of an object and corresponding times (e.g., timestamps) for the positions. In this regard, an acquired continuous data stream (e.g., image data or other sensor data) may be analyzed to identify or determine each object's trajectory. For example, the detection data generator 110 may process continuous stream data (e.g., a video, still images, LIDAR data, etc.) to identify one or more object(s) within the field of view of the sensor 102). In this regard, object detection may be performed to detect one or more objects within the continuous data stream (e.g., within a video represented by image data captured by a camera(s)). Object detection may be performed in any number of ways, such as, for example, via machine learning (e.g., convolutional neural networks) or other computer vision algorithms. Detected objects may be indicated in the detection data, for example, using a bounding box.

At step 315, the analysis service 120 within the remote device 255 transmits extraction trigger(s) to at least one of the multiple edge devices 130. The analysis service 120 may determine time segments corresponding to the event and include the time segments in the extraction trigger(s). At step 320, the at least one of the multiple edge devices 130 extracts clip(s) based on the extraction trigger(s). The clip(s) may be retrieved by a remote device 255 for further processing or for presentation to a user.

Detecting objects, instances, or occurrences at edge devices and performing analysis based on detection data collected by multiple edge devices enables identification of events in a larger context. Additionally, portions of the continuous data stream acquired by individual edge devices may be extracted to produce clips. Buffering the data stream for an amount of time equal to or greater than the latency incurred while the remote analysis is performed ensures the portions of the data stream are available to store as clips. The ability to determine the portions of the data stream to extract ensures that the persistent storage resources are used intelligently—to store the clips that are identified by analysis in the larger context and/or over time as being relevant. The stored clips may be used to perform additional analysis or for presentation.

### Parallel Processing Architecture

FIG. 4 illustrates a parallel processing unit (PPU) 400, in accordance with an embodiment. The PPU 400 may be used to implement one or more of the edge device(s) 130 or the analysis service 120. In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 565 may be configured to implement the method 200 shown in FIG. 2A and/or the method 300 shown in FIG. 3. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the method 200 shown in FIG. 2A and/or the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images and/or annotations generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used to train the analysis service 120 and/or the detection data generator 110.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

Images and/or annotations generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A computer-implemented method, comprising:
processing, at an edge device, a data stream acquired from a sensor and continuously buffered to produce detection data corresponding to at least one time segment in the data stream;
transmitting the detection data to a remote device;
receiving, by the edge device, a trigger generated by the remote device in response to processing of the detection data that identifies an event;
in response to the trigger, extracting a clip including at least a portion of the data stream that is continuously buffered by the edge device; and
storing the clip to a persistent storage by the edge device.

2. The computer-implemented method of claim 1, wherein the data stream is a video stream and the detection data corresponds to an object that is visible in the data stream.

3. The computer-implemented method of claim 1, wherein the data stream is an audio stream and the detection data corresponds to a sound that is audible in the data stream.

4. The computer-implemented method of claim 1, wherein the sensor comprises at least one of a camera or a microphone.

5. The computer-implemented method of claim 1, wherein the sensor comprises one or more of a light detection and ranging (LIDAR) sensor, infrared (IR) sensor, radio detection and ranging (RADAR) sensor, weather sensor, or speed sensor.

6. (canceled)

7. The computer-implemented method of claim 1, further comprising storing annotation data corresponding to the clip and included with the trigger to the persistent storage by the edge device.

8. The computer-implemented method of claim 1, wherein at least one additional edge device is configured to transmit additional detection data to the remote device.

9. (canceled)

10. The computer-implemented method of claim 1, wherein the analysis is performed by a neural network.

11. The computer-implemented method of claim 1, wherein the detection data is produced by a neural network.

12. The computer-implemented method of claim 1, wherein the edge device includes a buffer from which the clip is extracted, wherein the buffer continuously stores a portion of the data stream as the data stream is acquired and overwrites an oldest portion of the stored data stream.

13. The computer-implemented method of claim 1, wherein a communication service, connected to the edge device via a network, is configured to relay the detection data from the edge device to the remote device and relay the trigger from the remote device to the edge device.

14. The computer-implemented method of claim 1, wherein the remote device is located within a cloud computing environment.

15. The computer-implemented method of claim 1, wherein the steps of processing, transmitting, receiving, extracting, and storing generate data that are used for training, testing, or certifying a neural network model that is employed in a machine, robot, or autonomous vehicle.

16. The computer-implemented method of claim 1, wherein the steps of processing, transmitting, receiving, extracting, and storing are performed by a virtual machine hosted in a computing device that includes at least one of a processor or a graphics processing unit.

17. A system, comprising:
an edge device coupled to a persistent storage and configured to:
process a data stream acquired from a sensor and continuously buffered to produce detection data corresponding to at least one time segment in the data stream;
transmit the detection data to a remote device;
receive a trigger generated by the remote device in response to processing of the detection data that identifies an event;
in response to the trigger, extract a clip including at least a portion of the data stream that is continuously buffered by the edge device; and
store the clip to the persistent storage by the edge device.

18. The system of claim 17, wherein the data stream is a video stream and the detection data corresponds to an object that is visible in the data stream.

19. The system of claim 17, wherein the data stream is an audio stream and the detection data corresponds to a sound that is audible in the data stream.

20. A non-transitory computer-readable media storing computer instructions that, when executed by one or more processors, cause the one or more processors to perform the steps of:
processing a data stream acquired from a sensor and continuously buffered to produce detection data corresponding to at least one time segment in the data stream;
transmitting the detection data to a remote device;
receiving a trigger generated by the remote device in response to processing of the detection data that identifies an event;
in response to the trigger, extracting a clip including at least a portion of the data stream that is continuously buffered by the edge device; and
storing the clip to a persistent storage by the edge device.

21. The computer-implemented method of claim 2, wherein the event is associated with movement of the object over time.

22. The computer-implemented method of claim 12, wherein a capacity of the buffer accommodates latency from a time starting when the data stream is acquired and ending after the clip is extracted.
